(19) United States
(12) Patent Application Publication
(10) Pub. No.: US 2004/0236760 A1
(43) Pub. Date: Nov. 25, 2004

(54) Systems and methods for extending a management console across applications

(75) Inventors: Woodrow Wyatt Arkeketa, Austin, TX (US); Dah-Haur Lin, Austin, TX (US); Vijaylaxmi Chakravarty, Austin, TX (US); Shengdong Chen, Cedar Park, TX (US)

Correspondence Address: Barry S. Newberger, 1201 Main Street, P.O. Box 50784, Dallas, TX, 75250-0784, US

(73) Assignee: International Business Machines Corporation

(21) Appl. No.: 10/443,668

(22) Filed: May 22, 2003

(51) Int. Cl. G06F 7/00

(52) U.S. Cl. 707/100

(57) ABSTRACT

A mechanism for extending user interfaces applied in conjunction with a data processing system platform is provided. In particular, mechanisms for extending such interfaces across software resources, or applications, is provided. A management agent is implemented to mediate actions supported by the user interface and the application functionality. The user interface communicates with the management agent to provide the parameters required by the application. The agent contacts the application which provides the required functionality, for example, a security context for a user. The agent may then perform other management related operations, for example, importing a management object into a management access system.

### TECHNICAL FIELD

The present invention is related to enterprise data processing systems, and in particular, to systems and methods for managing such enterprise data processing systems, and extending management components and resources to provide additional functional support to achieve application-specific management operations.

### BACKGROUND INFORMATION

Modem data processing systems, particularly in enterprise environments, are increasingly reliant on the use of distributed resources to provide information services to users. These resources may include hardware services, such as printing services as well as software resources, such as the familiar e-mail services, database management services and other, specialized application services particular to the enterprise. Additionally, these systems provide for the management of the resources within the system, for example, access management services for the resources, whether hardware or software. Typically, these access services provide system administration services by which administrators can establish security policies and security contexts for the users and resources on the system.

Additionally, modem data processing platforms (or, operating systems) typically include resources which may be used with, or adapted for use with software and other resources deployed on the data processing system. For example, Windows 2000™ includes the Active Directory Service which may be used in conjunction with administrative operations in an enterprise data processing environment. These resources may be provided in conjunction with user interfaces adapted for mediating the management of these administrative tools by users, that is, system administrators. For example, the previously mentioned Active Directory Service may be used in conjunction with the Microsoft® Management Console (MMC) to manage the Active Directory Service.

Such user interfaces, which typically present a substantially uniform graphical user interface (GUI) representation across the managed resources may be advantageous in reducing the need to learn a multiplicity of management interfaces. However, these resources typically are not adapted for use with pre-existing applications within the enterprise data processing environment. Thus, there is a need in the art for mechanisms to integrate platform-supplied resources, particularly management resources within these environments, with functionality provided by resources in the data processing environment for which there are no platform supplied adaptation modules.

### SUMMARY OF THE INVENTION

The aforementioned needs are addressed by the present invention. Accordingly, there is provided in one embodiment a computer program product embodied in a tangible storage medium. The computer program product includes a program of instructions accessing an application-specific management operation by a management agent. The application-specific operation is a functionality of a predetermined application. The management console is operable for performing a predetermined set of management operations. The predetermined set of management operations excludes the application-specific management operation. Additionally, the management console constitutes a standard platform component. The computer program product also includes programming instructions for sending at least one parameter from the management console to the agent using a first communication protocol. The parameter or parameters constitute(s) input parameter(s) of the application-specific management operation.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates, schematically, a distributed data processing environment which may be used in conjunction with the present invention;

FIG. 2 illustrates, in block diagram form, an architecture for integrating a management console across management applications in accordance with the present inventive principles;

FIG. 3 illustrates, in flowchart form, a user interface portion of a process for extending a management console in accordance with the principles of the present invention;

FIG. 4 illustrates, in flowchart form, a management agent process for extending a management console in conjunction with the process of FIG. 3;

FIG. 5 illustrates, in flowchart form, a process for creating a management object into a management database for use in conjunction with the processes of FIGS. 4 and 5;

FIG. 6 illustrates, in flowchart form, a process for importing a management object into a management database in accordance with an embodiment of the present invention; and

FIG. 7 illustrates, in block diagram form, a data processing system which may be used in conjunction with the methodologies incorporating the present inventive principles.

### DETAILED DESCRIPTION

A mechanism for extending user interfaces supplied in conjunction with a data processing system platform is provided. In particular, mechanisms for extending such interfaces across software resources, or applications, is provided. A management agent is implemented to mediate actions supported by the user interface and the application functionality. The user interface communicates with the management agent to provide the parameters required by the application. The agent contacts the application which provides the required functionality, for example, a security context for a user. The agent may then perform other management related operations, for example, importing a management object into a management access system.

In the following description, numerous specific details are set forth to provide the thorough understanding in the present invention. For example, in particular operating systems, or platforms, and particular operating system resources may be referred to, however, it would be recognized by those of ordinary skill in the art that the present invention may be practiced without such specific details, and in other instances, well-known circuits have been shown in block diagram form in order not to obscure the present invention in unnecessary detail. Refer now to the drawings, wherein depicted elements are not necessarily shown to scale and wherein like or similar elements are designated by the same reference numeral through the several fuse.

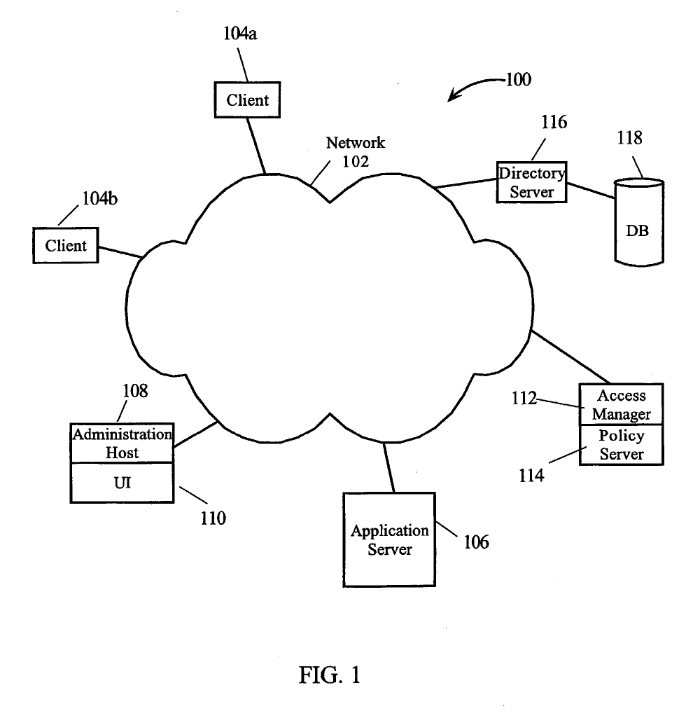

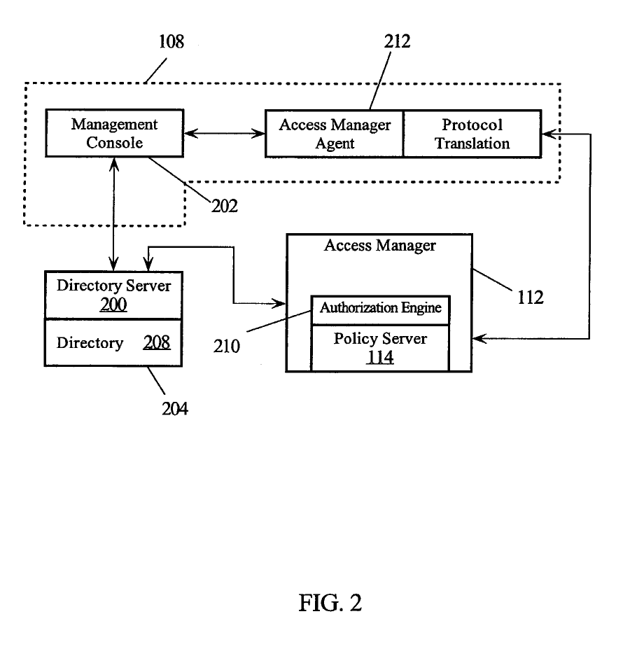

FIG. 1 illustrates, schematically, a distributed data processing environment which may be used in conjunction with the present invention. Data processing environment 100 of FIG. 1 is exemplary, and provides a contextual frame work for the further description of the present invention in FIGS. 2-6, below. Distributed data processing environment 100 includes a network 102 which may be a local area network (LAN), a wide area network (WAN) or even a network of network, such as the Internet. Clients 104a and 104b, attached to network 102, may be devices associated with users such as a work station or personal computer. Users, via the clients, (104a or 104b) use distributed data processing resources attached to the network. These may include hardware resources, such as printers, or software resources, for example, distributed applications, electronic mail, database management services, etc. These are generically indicated in FIG. 1 by application server 106.

Distributed data processing resources which may include network 102 itself, may be managed by one or more administrators. An administrative host 108, which may be a general purpose work station on which data processing system administrative applications are deployed, may also be attached to network 102. As previously noted, management resources may be accessed and controlled via a user interface 110 which may be displayed on an administrative host 108 and receive user input to effect management operations with respect to distributed data processing environment 100.

These network management functions may include access management operations. Accordingly, data processing resources related to access management may also be deployed on network 102. These are exemplified by access manager 112 which may include a policy server 114. A policy server, such as policy server 114, may process access control requests. Such requests may be received from users seeking to be granted access to resources in distributed data processing environment 100. Other resources that may be associated with management services include a directory server 116 and an associated database 118. Database 118 may include, for example, a registry of users which stores user objects that may contain user's sign-on password, user's password history, user's certificate, user's principal name, user's group membership, user's account control, user's sign-on records. It would be recognized by those of ordinary skill in the art that this list is not exhaustive, and alternative implementations may not include all of these and may include other attributes corresponding to a particular user. As will be described further hereinbelow, users may be logically represented in the database as user objects which serve as a container for user attributes. Note that although directory server 116 and database 118 have been shown in FIG. 1 as separate from access manager 112 and policy server 114 has been illustrated in conjunction with access manager 112, it would be appreciated by those of ordinary skill in the art that the illustrations in FIG. 1 are not necessarily indicative of particular hardware embodiments of a distributed data processing environment. In other words, FIG. 1 may be viewed as a logical representation of an exemplary distributed data processing environment which may be implemented by a variety of hardware and software configurations. It would be appreciated by those of ordinary skill in the art that such alternative hardware and software configurations may be used in conjunction with the present inventive principles.

Refer now to FIG. 2 which illustrates an architecture 200 for extending a user interface to an application that requires additional functional support to achieve application-specific management operations. In particular, architecture 200 will be discussed in conjunction with a user interface represented by management console 202. Additionally, an embodiment of the present invention may be used with the Microsoft® management console (MMC). Management console 202 may be deployed on an administrative host 108. Additionally, architecture 200 is discussed in the context of access management services, however, the present inventive principles may be applied to any application that requires additionally function support to achieve management operations in conjunction therewith.

Note also that the user interface, here management console 202, performs operations that typically in response to user input, effects the control of management resources in a data processing environment, as discussed hereinabove in conjunction with FIG. 1. In other words, the user interface provides not only a mechanism to receive user input, but implements actions to manage system resources. For example, management console 202 may include one or more modules for controlling a directory service 204 including directory server 206 and directory 208. For example, the Microsoft® Management Console is adapted, or may be adapted, to manage a directory service implemented using the Microsoft® Active Directory directory service (modules for adapting the Microsoft® management console to provide particular management operations may be referred to as “snap-ins”).

In the access management context, directory service 204 may be used as a user registry. As noted in conjunction with FIG. 1, the user registry may hold user objects, a container object for holding attributes associated with the user corresponding to the particular user object. The registry may also contain other objects, such as: group objects, a container object for storing group associated attributes; a policy object, a container object for holding access manager global policy as well as individual user's policy, resource and resource group objects that represent different backend server objects to the access manager; and the resource credential objects that store user-specific sign-on information to individual backend servers. These objects may be used in conjunction with the security context for a protected resources to establish access authorizations with respect to the protected resource and user.

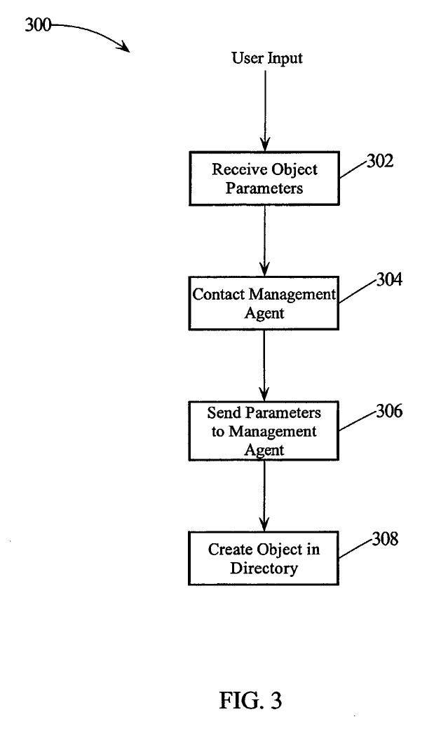

To provide for this functionality, a user object recognized by the access manager must be created in the directory. This entry may be used by an authorization engine to make authorization decisions when the user attempts to access a particular protected resource. To link the access manager user object with a native user identifier in the directory service, access manager agent 212 implements an interface between management console 202 and access manager 214. The operation of access manager agent 212 will be discussed in conjunction with FIGS. 3-5, below. In this way, the native functionality provided by management console 202 may be transparently extended to provide application-specific functionality, namely access management functionality via access manager 112.

Refer now to FIG. 3 illustrating methodology 300 for creating a native management object in a registry in conjunction with a management console. Methodology 300 may, for example, be used with management console 202 and a registry embodied in a directory service, such as directory service 204, FIG. 2.

In step 302, the object parameters of the object to be created are received by a user input. Recall that the management console presents a user interface, typically a GUI that enables a user to enter input data. These input data may include, for example, user's sign-on ID, user object location in the registry (or, Distinguished Name), user's first name, user's last name, description to the user, and user's sign-on password.

In step 304, the management agent is contacted. A mechanism in accordance with the TCP/IP communication protocols for establishing the connection between MMC and the management agent may in a Unix environment run the management agent as a daemon process alternatively in a Windows environment as a service. In either case, a secure connection with the application (such as the access manager application) is established at the start of the system. Thereafter, it listens for requests from MMC on a predetermined port. When MMC performs an application specific operation, it sends the necessary parameters of the operation to the management agent (i.e. the daemon or service process). The agent then makes application specific calls to complete the operation requested, and send the result, either successful or failure with error returned message, back to the MMC.

[Although the foregoing represents an embodiment using TCP/IP to establish the connection between the MMC and the management agent, persons of ordinary skill in the art would appreciate that the present inventive principles are not predicated as the particular communication protocol, and other communications, for example named pipes, file, etc., may be used in conjunction therewith. The connection can instead use any other communication protocol such as named pipes, files etc.] In step 306 the parameters of the object being created, received in step 302, are sent to the management agent.

In step 308, the native object is created in the directory. For example, if a user object is being created, the user object attributes may include a user name, user ID (UID), and user sign-on password. In addition, there may be internal system attributes, such as: user logon time, password history, objectGUID, etc., that may be set at the time when the native object is created automatically by the system. Optionally, the user interface GUI may also include other optional panels to allow the administrator to input other attributes that may be stored by the user object. Recall, too, that in an embodiment of the present invention, the directory may be implemented using the Microsoft® Active Directory service.

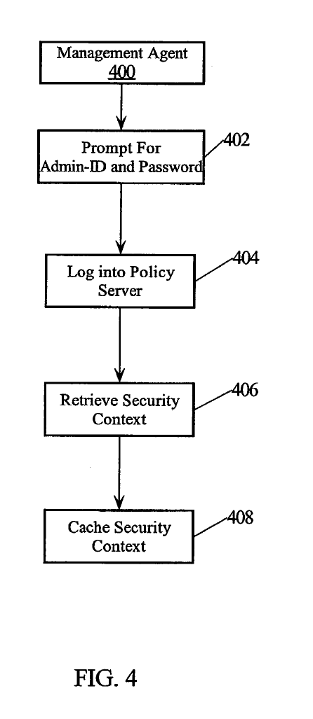

Refer now to FIG. 4 illustrating management agent process 400 in accordance with the present inventive principles. In step 402, process 400 prompts for an administrator identifier (“ADMIN-ID”) and password. The ADMIN-ID may correspond to the user identifier and password associated with an access manager administrator. In step 404, process 400 logs into an access management policy server. This may correspond to policy server 114 in an embodiment in accordance with the architecture 200 illustrated in FIG. 2.

In step 406, the access manager security context is retrieved. (For purposes herein, a security context may be understood in the security rules or policies defining the authority of the administrator having the ADMIN-ID from step 402. In step 408, the security context is cached.

Note that the communication between the management console and management agent may use one protocol, TCP/IP say, while another communication protocol may be used between the management agent and the application, named pipes, for example. Referring again to FIG. 2, in the architecture 200 illustrated therein, a protocol translator 214 may be used to provide a mapping between the different communication protocols.

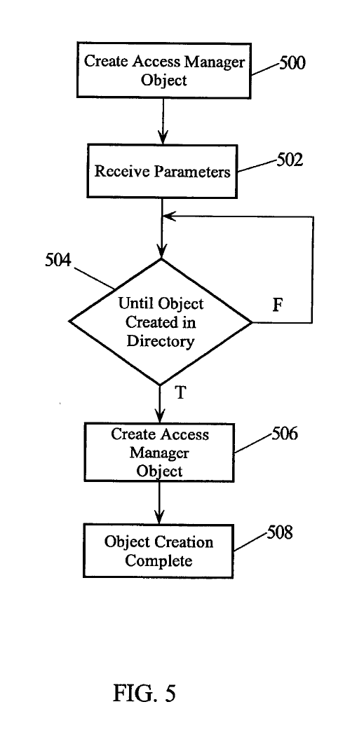

Refer now to FIG. 5 illustrating a process for creating an object in the directory. Create process 500 may also be performed by an access manager agent, such as access manager agent 212, FIG. 2. In step 502, the parameters set by the management console are received. In step 504, import process 500 loops until the object is created in the directory. That is, process 500 waits for the native object to be created in the directory. As previously described, the creation of the native object, a user object for example, in the directory is performed by the management console. In step 504, the creation of the native object in the directory may be determined by polling the directory service for the object. The parameters received in step 502 may be used to effect the polling.

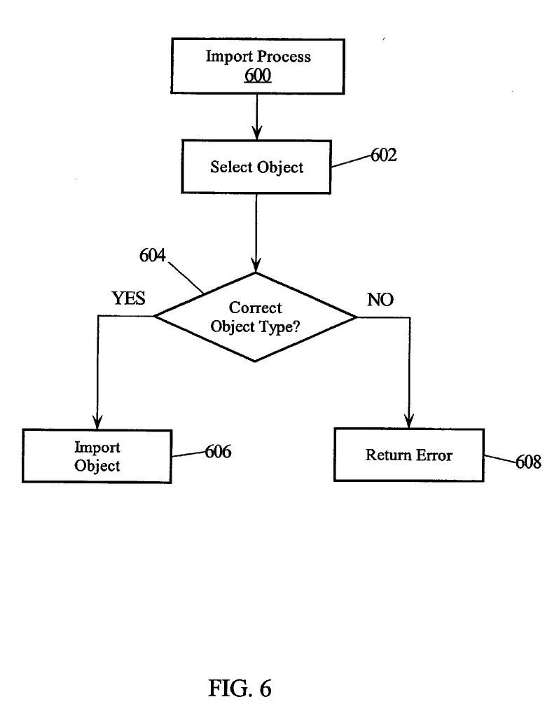

When it is determined that the native object exists in the directory, in step 506, the access manager object is created in the access manager database. In other words, in importing the native object (discussed in conjunction with FIG. 6), a corresponding object recognized by the function-specific application, exemplified by the access manager in the embodiment of FIGS. 2 and 5, is first created. The access manager object, for example, a user object, may then be imported by storing application-specific data in the object, access manager specific data for the object and linking the native object.

Refer now to FIG. 6, illustrating in flowchart form, import process 600 in accordance with an embodiment of the present inventive principles. In step 602, the object to be imported into the access manager is selected. In step 602, the native object, say user object, to be imported into access manager product is identified, by, for example, a system administrator. In step 604, which the object's type of the object selected in step 602 is evaluated. If the selected object's type is valid (i.e. can be imported to access manager), then the object is imported (i.e. creating an associated access manager object) in step 606. Returning to FIG. 5, objection creation is completed in step 508. If, however, in step 604, the object selected is not a valid type, an error message is returned from access manager's policy server (e.g. policy server 114, FIG. 1) to the administrator indicating that the import operation has failed.

In this way, a native user object may be linked to the corresponding access manager user object. Thus, in importing the object, a user object, for example, the application-specific object is linked to the native object created in the directory, for example in step 308, FIG. 3, and application specific data is stored in the directory. A native object may include the user's logon name, first name, last name, password, etc. stored in the registry. For an application specific object, however, it may contain only application specific permissions, security policies, access rights, group membership, and any other application specific attributes that the application needs to support its operations. Note that the same directory may be used for containing both the native object and the application-specific object.

Thus, applications that, for example, require access authorization services may implement this functionality transparently. The application may implement its authorization functionality using the native objects, such as native user objects, or may use the services of the access manager. In the latter case, the access manager effects the authentication using the links between the access manager object and the native object.

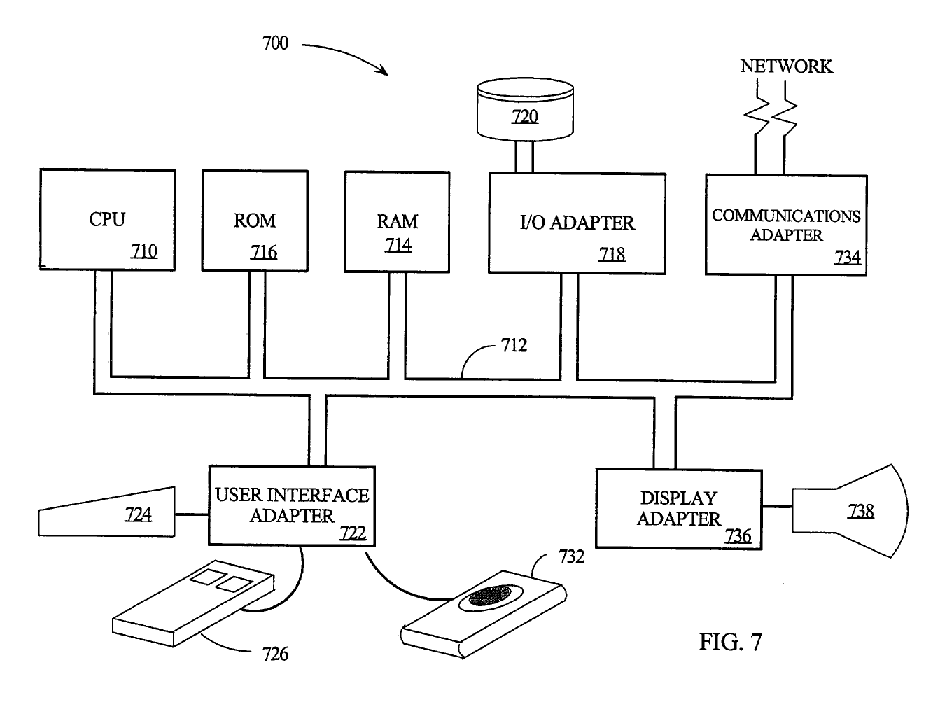

FIG. 7 illustrates an exemplary hardware configuration of data processing system 700 in accordance with the subject invention. The system, in conjunction with the methodologies illustrated in FIGS. 3-5 may be used, for extending a management console across applications in accordance with the present inventive principles. Data processing system 700 includes central processing unit (CPU) 710, such as a conventional microprocessor, and a number of other units interconnected via system bus 712. Data processing system 700 also includes random access memory (RAM) 714, read only memory (ROM) 716 and input/output (I/O) adapter 718 for connecting peripheral devices such as disk units 720 to bus 712, user interface adapter 722 for connecting keyboard 724, mouse 726, trackball 732 and/or other user interface devices such as a touch screen device (not shown) to bus 712. System 700 also includes communication adapter 734 for connecting data processing system 700 to a data processing network, enabling the system to communicate with other systems, and display adapter 736 for connecting bus 712 to display device 738. CPU 710 may include other circuitry not shown herein, which will include circuitry commonly found within a microprocessor, e.g. execution units, bus interface units, arithmetic logic units, etc. CPU 710 may also reside on a single integrated circuit.

Preferred implementations of the invention include implementations as a computer system programmed to execute the method or methods described herein, and as a computer program product. According to the computer system implementation, sets of instructions for executing the method or methods are resident in the random access memory 714 of one or more computer systems configured generally as described above. These sets of instructions, in conjunction with system components that execute them may, for example, create objects in a directory and import them into an access management service as described hereinabove. Until required by the computer system, the set of instructions may be stored as a computer program product in another computer memory, for example, in disk drive 720 (which may include a removable memory such as an optical disk or floppy disk for eventual use in the disk drive 720). Further, the computer program product can also be stored at another computer and transmitted to the users work station by a network or by an external network such as the Internet. One skilled in the art would appreciate that the physical storage of the sets of instructions physically changes the medium upon which is the stored so that the medium carries computer readable information. The change may be electrical, magnetic, chemical, biological, or some other physical change. While it is convenient to describe the invention in terms of instructions, symbols, characters, or the like, the reader should remember that all of these in similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

Although the present invention and its advantages have been described in detail, it should be understood that various changes, substitutions and alterations can be made herein without departing from the spirit and scope of the invention as defined by the appended claims.

What is claimed is:

1. A computer program product embodied in a tangible storage medium, the program product comprising programming instructions, the programming instructions including instructions for:
accessing an application-specific management operation by a management agent, wherein the application-specific operation is a functionality of a predetermined application;
wherein the management console is operable for performing a predetermined set of management operations, wherein said predetermined set of management operations excludes the application-specific management operation and said management console comprises a standard platform component; and
sending at least one parameter from said management console to said agent using a first communication protocol, wherein said at least one parameter comprises an input parameter of said application-specific management operation.

2. The program product of claim 1 further including instructions for:
creating a first management object in a directory using an operation of said predetermined set of management operations, said first parameter comprising an attribute of said first object;
responsive to said step of creating said first management object, importing said first management object into said application-specific management operation, said management agent creating a second management object in said directory in response to said step of importing said first management object.

3. The program product of claim 2 further including instructions for retrieving a security context from a policy server, wherein said management agent authenticates the step of importing said first management object with said security context.

4. The program product of claim 2 wherein an attribute of said second management object comprises said at least one parameter.

5. The program product of claim 3 wherein said application-specific management operation comprises an access management operation.

6. The program product of claim 2 further including instructions for prompting for an administrator identifier and password, wherein said management agent retrieves said security context in response to said administrator identifier and password, said management agent caching said security context.

7. The program product of claim 3 wherein the security context is retrieved using a second communication protocol.

8. A method for extending a management console comprising:
providing an agent for accessing an application-specific management operation, wherein the application-specific operation is a functionality of a predetermined application;
wherein the management console is operable for performing a predetermined set of management operations, wherein said predetermined set of management operations excludes the application-specific management operation and said management console comprises a standard platform component; and
sending at least one parameter from said management console to said agent using a first communication protocol, wherein said at least one parameter comprises an input parameter of said application-specific management operation.

9. The method of claim 8 further comprising:
creating a first management object in a directory using an operation of said predetermined set of management operations, said first parameter comprising an attribute of said first object;
responsive to said step of creating said first management object, importing said first management object into said application-specific management operation, said management agent creating a second management object in said directory in response to said step of importing said first management object.

10. The method of claim 9 further comprising retrieving a security context from a policy server, wherein said management agent authenticates the step of importing said first management object with said security context.

11. The method of claim 9 wherein an attribute of said second management object comprises said at least one parameter.

12. The method of claim 10 wherein said application-specific management operation comprises an access management operation.

13. The method of claim 9 further comprising prompting for an administrator identifier and password, wherein said management agent retrieves said security context in response to said administrator identifier and password, said management agent caching said security context.

14. The method of claim 10 wherein the security context is retrieved using a second communication protocol.

15. A data processing system comprising:
circuitry operable for accessing an application-specific management operation by a management agent, wherein the application-specific operation is a functionality of a predetermined application;
wherein the management console is operable for performing a predetermined set of management operations, wherein said predetermined set of management operations excludes the application-specific management operation and said management console comprises a standard platform component; and
circuitry operable sending at least one parameter from said management console to said agent using a first communication protocol, wherein said at least one parameter comprises an input parameter of said application-specific management operation.

16. The data processing system of claim 15 further including:
circuitry operable for creating a first management object in a directory using an operation of said predetermined set of management operations, said first parameter comprising an attribute of said first object;
responsive to said step of creating said first management object, circuitry operable for importing said first management object into said application-specific management operation, said management agent creating a second management object in said directory in response to said importing said first management object.

17. The data processing system of claim 16 further including circuitry operable for retrieving a security context from a policy server, wherein said management agent authenticates the step of importing said first management object with said security context.

18. The data processing system of claim 16 wherein an attribute of said second management object comprises said at least one parameter.

19. The data processing system of claim 17 wherein said application-specific management operation comprises an access management operation.

20. The data processing system of claim 16 further including circuitry operable for prompting for an administrator identifier and password, wherein said management agent retrieves said security context in response to said administrator identifier and password, said management agent caching said security context.
